(19) United States
(12) Patent Application Publication
(10) Pub. No.: US 2025/0028630 A1
(43) Pub. Date: Jan. 23, 2025

(54) METHOD FOR EVALUATION OF FEATURE FLAGS

(71) Applicant: DevRev, Inc., Palo Alto, CA (US)

(72) Inventor: Brian BYRNE, Issaquah, WA (US)

(73) Assignee: DevRev, Inc., Palo Alto, CA (US)

(21) Appl. No.: 18/354,556

(22) Filed: Jul. 18, 2023

(51) Int. Cl. G06F 11/36; G06F 8/71

(52) U.S. Cl. CPC G06F 11/3692; G06F 8/71; G06F 11/368

(57) ABSTRACT

A system and method to facilitate the evaluation of feature flags. The feature flags are operated by a set of rules also defined as a policy and these feature flags operate only when such conditions as prescribed in the policy are satisfied. The system and method define and store rules in a repository by assigning a unique identifier to each rule. Further, when a rule is updated, the new rule is assigned a new version identifier. A declarative query language is used for the rules to allow rule evaluation where inputs are provided to the rule evaluation that affects the resulting value. The system and method generated a defined type and an undefined type of response data as output after the evaluation of the input data.

### FIELD OF THE INVENTION

The subject matter of the present invention relates to feature flags as a service. Particularly and not exclusively, the subject matter of the present invention is related to an effective and reliable system and method for the evaluation of feature flags.

### BACKGROUND OF THE INVENTION

In traditional systems, changes to the underlying software may be required to affect changes in the running system. To enact these changes, code developers with knowledge of the internals of the system make the requisite modifications and execute the deployment of the changed code to update the software services. Even if the changes are trivial the entire code needs to be deployed for testing and running which is cumbersome.

Feature flags are a software development concept that allows enabling or disabling (conditional statement) a feature without modifying the source code or requiring a redeployment. A feature flag ranges from a simple ‘IF’ statement to more complex decision trees, which act upon different variables. Expressions (rules) for evaluating values (flags) are distributed on a control plane to all software services, which are then loaded at the service's initialization and kept up to date as the rules are modified. The adoption of the changes is then done without the need for updating or restarting any software services. This process enables rapid deployment of flag rule changes and enables a broader range of users to make the changes since intricate knowledge of the software service for evaluating the logic is not necessary.

When multiple rule updates occur, there exists a need to identify the newly updated rules from the old ones, and manually managing such changes is impractical. Hence, there is a need for improved systems and methods that provide a technical solution for solving the technical problem of evaluating the feature flags by identifying any changed rules.

### SUMMARY OF THE INVENTION

One or more implementations of the present specification provide a system for evaluation of the feature flags. To achieve the objective above, one or more implementations of the present specification provide the following technical solutions:

An aspect of one or more implementations of the present specification is to provide an effective, reliable system and method to define the rules for evaluating flags. The system and method define and store rules in a repository by assigning a unique identifier to each rule. Further, when a rule is updated, the new rule is assigned a new version identifier. Each rule is defined with a unique identifier and a version identifier, where the version identifier changes when the rule is updated. A declarative query language is used for the rules to allow rule evaluation where inputs are provided to the rule evaluation that affects the resulting value.

The definition of the flags' rules or set of rules is called the policy. The policy (rules) is stored in a durable and available location, like a repository of a source version control system on distributed storage. The new rules with the new identifiers are stored in the repository along with the old set of rules and identifiers. The version control system is used to keep track of versions of a set of files, usually to allow multiple developers to collaborate on a project. The repository keeps track of the files in the project and the changes to the files can be tracked through version history.

Another aspect of the present specification is to provide an effective, reliable feature flag service that can identify/detect changes to the rules for evaluating flags and distributing them to various software services. Changes to the policy (rule) are prepared by creating version control system pull requests on the repository and enacted when the pull request is merged. Each version of the rule has a unique identifier which is used to detect changes without comparing the complete set of rules or policy. The present system (feature flag as a service) is constantly monitoring policy (set of rules) for any changes and listening for any new individual services that have just initialized and want to use the current policy in their application. When a change in the policy is determined, the feature flag service will propagate the changes to all connected clients immediately.

In another aspect, the present system is in communication with client systems that use the system's software services and receive rule changes to simplify the evaluations of flags. The system's other software services are listening for changes to the policy (set of rules). Once detected, they transparently reload the updated rule that is used for evaluating the flag. When handling requests, they will use the stored rule (updates if any) and evaluate it against the desired inputs (in this case the contextual data) to calculate the output which may be a Boolean, a numeric value, a string, or an object.

In another aspect, the system distinguishes between static (environment) and dynamic (contextual) inputs. This has performance benefits because rules with static inputs can be partially evaluated and cached at policy update time, rather than evaluated at runtime, eliminating redundant work.

In another aspect, during the evaluation of the flags, the outputs can be in the form of a Boolean, and the present feature flag service does not evaluate to {true, false}, but rather {true, false, undefined} (or for string/numeric flags, also add the ‘undefined’ value). If an unrecognized or incompatible input is provided, rather than erroneously evaluating a ‘true/false’ value, the present feature flag service will define it as an ‘undefined’ value or ‘undefined input’ as output which thereby requests the developer's attention to check the input variables as whether they are consistent with the defined rule or policy.

Other objects, aspects, features, and goals of the present invention will be better understood from the following detailed description. The following description is illustrative in nature and is not intended to be in any way limiting. In addition to the illustrative aspects, embodiments, and features described above, further aspects, embodiments, and features will become apparent by reference to the following detailed description.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the embodiments taken in conjunction with the accompanying drawings wherein like reference letters and numerals indicate the corresponding parts in various figures in the accompanying drawings, and in which:

FIG. 1 illustrates a schematic block diagram of the feature flag as service in accordance with an embodiment of the present specification.

FIG. 2 illustrates a process flow of updating policy to evaluate flags in accordance with an embodiment of the present specification.

FIG. 3 illustrates a process flow of defining and updating the rules in accordance with an embodiment of the present specification.

FIG. 4 illustrates a process flow of evaluation of flags in accordance with an embodiment of the present specification.

FIG. 5 illustrates a process flow of evaluation of flags using contextual input data in accordance with an embodiment of the present specification.

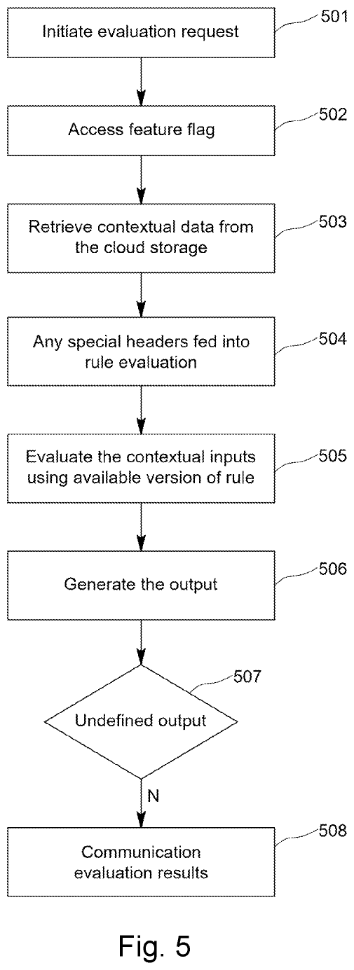

FIG. 6 is a block diagram of an illustrative computing system suitable for implementing an embodiment of the present invention.

### DETAILED DESCRIPTION OF THE PREFERRED AND/OR ILLUSTRATED EMBODIMENTS OF THE PRESENT INVENTION

Example implementations are described in detail here, and examples of the example implementations are presented in the accompanying drawings. When the following description relates to the accompanying drawings, unless specified otherwise, the same numbers in different accompanying drawings represent the same or similar elements. The implementations described in the following example implementations do not represent all implementations that are consistent with one or more implementations of the present specification. On the contrary, the implementations are only examples of apparatuses and methods that are described in the appended claims in detail and consistent with some aspects of one or more implementations of the present specification.

It is worthwhile to note further that the term “includes”, “contains”, or any other variant is intended to cover a non-exclusive inclusion, so that a process, a method, merchandise, or a device that includes a list of elements not only includes those elements but also includes other elements which are not expressly listed, or further includes elements inherent to such process, method, merchandise, or device. An element preceded by “includes a . . . ” does not, without more constraints, preclude the existence of additional identical elements in the process, method, merchandise, or device that includes the element.

The terms used in one or more implementations of the present specification are merely used for the purpose of describing specific implementations and are not intended to limit one or more of the implementations of the present specification. The terms “a”, “said”, and “the” of singular forms used in the present specification and the appended claims are also intended to include plural forms unless otherwise specified in the context clearly. It should also be understood that the term “and/or” used in the present specification indicates and includes any or all possible combinations of one or more associated listed items.

The present specification is related to the feature flags service and a method of evaluation of the flags. Feature flags are development tools for modifying features at runtime without modifying the source code of an application or software. Thus, a feature flag ranges from a simple IF statement to more complex decision trees, which act upon different variables. The feature flags are operated by a set of rules also defined as a policy and these feature flags operate only when such conditions as prescribed in the policy are satisfied. In other words, feature flags allow developers or coders to deliver context-sensitive software quickly and efficiently. Feature flags have a wide range of applications for everything from supporting agile development to market testing to streamlining ongoing operations.

The known properties and advantages of feature flags are they improve deployment frequency because developers can deploy at any time. Even if there is unfinished code in the codebase, it can be hidden behind a feature flag. The main branch is always deployable; they improve lead time because a change can be deployed even if it's not finished yet, to gather feedback from key users; they improve the meantime to restore because the developer can revert a problematic change by just disabling the corresponding feature flag; and they improve change failure rate because they decouple the risk of deployment with the risk of change. A deployment no longer fails and must be rolled back because of bad features. The deployment is successful even if you have shipped a bad change because you can disable the bad change at any time by updating a feature flag.

The present specification discloses a feature flag as a service that facilitates rapid deployment of flag evaluation policy without software deployment. It further supports dynamic service-level inputs when evaluating a rule and facilitates aggressive caching to improve performance.

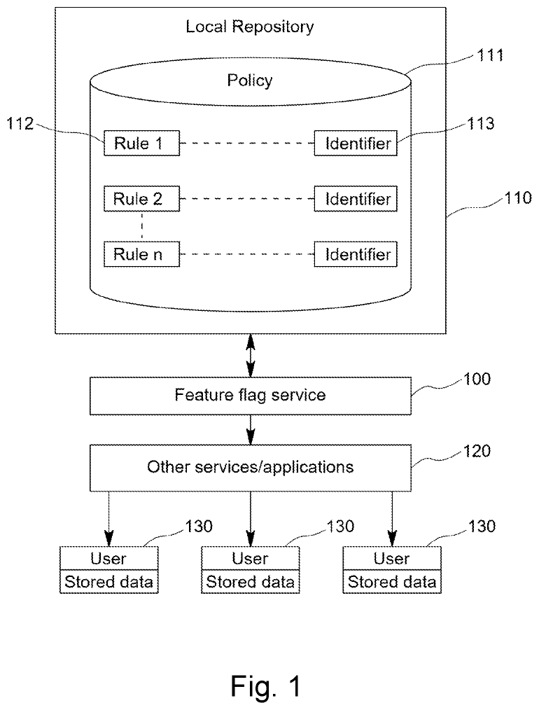

In the embodiment as shown in FIG. 1, the present system for evaluation of feature flags allows defining and storing a set of rules 112 also known as policy 111 in repository 110 by assigning a unique identifier 113 to each rule 112. Further, when rule 112 is updated, the new rule is assigned a new version identifier. A declarative query language is used to define a policy 111 to allow rule evaluation where inputs are provided to the rule evaluation that affects the resulting value.

The definition of the flags' rules or set of rules 112 is called policy 111. Policy 111 (rules) is stored in a durable and available location, like repository 110 of a source version control system on distributed storage. The new rules with the new identifier are stored in the repository along with the old set of rules and identifiers. The version control system is used to keep track of versions of a set of files, usually to allow multiple developers to collaborate on a project. Repository 110 keeps track of the files in the project and the changes to the files can be tracked through version history.

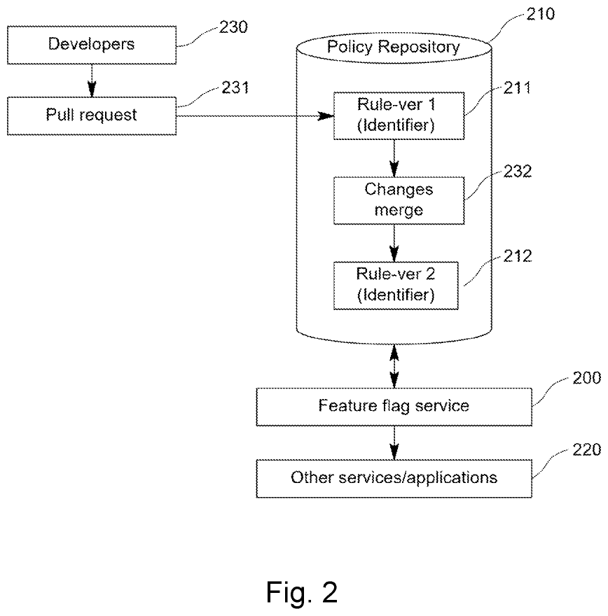

In the embodiment as shown in FIG. 2, the feature flag service 200 monitors the policy stored in the repository 210, and it can identify/detect changes to the rules for evaluating flags and further facilitate distributing such feature flags with updated rules to various software services. Changes to the policy are prepared by creating pull request 231 on the repository 210 by the developers 230 and enacted when the pull request 231 is merged 232. Each version of rule 211 has a unique identifier which is used to detect changes (the latest version of rule 212) without comparing the complete set of rules or policy. The present system 200 (feature flag as a service) is constantly monitoring policy (set of rules) for any changes and listening for any new individual services 220 that have just initialized and want to use the current policy in their application. When a change in the policy is determined, the feature flag service 200 will propagate the changes to all connected clients 220 immediately.

In another embodiment, the present system 200 is in communication with client systems 220 uses the system's 200 software services, and receives rule changes 212 to simplify the evaluations of flags. The system's other software services are listening for changes to the policy (set of rules). Once detected, they transparently reload the updated rule 212 that is used for evaluating the flag. When handling evaluation requests, they will use the stored rule (updates if any) and evaluate it against the desired inputs (in this case the contextual data) to calculate the output which may be a Boolean, a numeric value, a string, or an object.

In another embodiment, system 100 distinguishes between static (environment) and dynamic (contextual) inputs. This has performance benefits because rule 112 with static inputs can be partially evaluated and cached at policy update time, rather than evaluated at runtime, eliminating redundant work. It must be emphasized that the policy (instructions or rules) are locally stored and there are no dynamic inputs to the feature flag, and the client will generate the result of the evaluation when receiving the policy and cache the value. This means that subsequent evaluations of the flag immediately return a value and do not require communicating with the feature flag service. Only when the client receives a new policy does it clear its cache.

In another embodiment, the feature flag service 100 allows conditional feature flags wherein the developer will be able to enable the feature flag for some users while disabling it for others. Feature filters determine the state of the feature flag each time it's evaluated. For example a filter for a numeric flag to evaluate for 0-100 value only. The conditional feature flag state applies to a percentage of all users. This can be applied for progressive rollouts, where enabling a feature for a small percentage of users and then slowly increasing the percentage (or setting it back to 0 if users complain about the feature not working). This rollout strategy is context-sensitive in the sense that it knows which user it is serving.

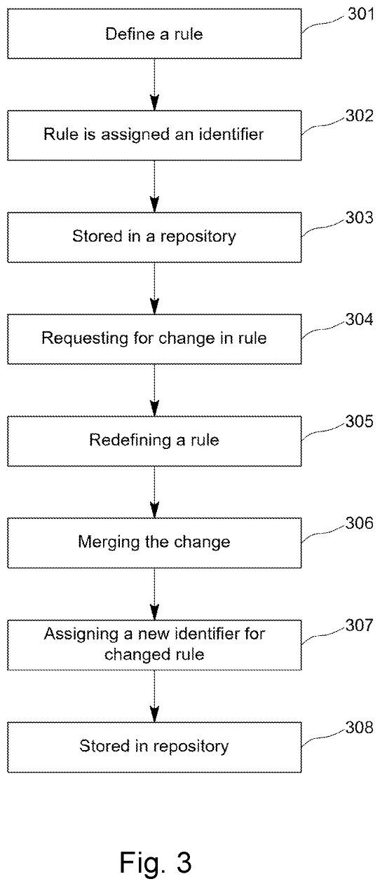

Referring to FIG. 3, the present specification allows defining rules in the declarative query language. The method of defining and updating the rules in a policy comprises steps of defining a rule 301 in declarative query format; assigning an identifier 302 to the defined rule; storing 303 the defined rule with an identifier in a repository; and updating the rule: initiating update request 304; redefining the rule 305; merging the update request 306; assigning a new identifier 307 to the updated version of rule; and storing 308 in the same repository.

In an embodiment, the rules are defined using a declarative query language like Rego. Rego is the purpose-built declarative policy language that supports Open Policy Agent (OPA). It's used to write policies that are easy to read and easy to write. Fundamentally, Rego inspects and transforms data into structured documents, allowing OPA to make policy decisions.

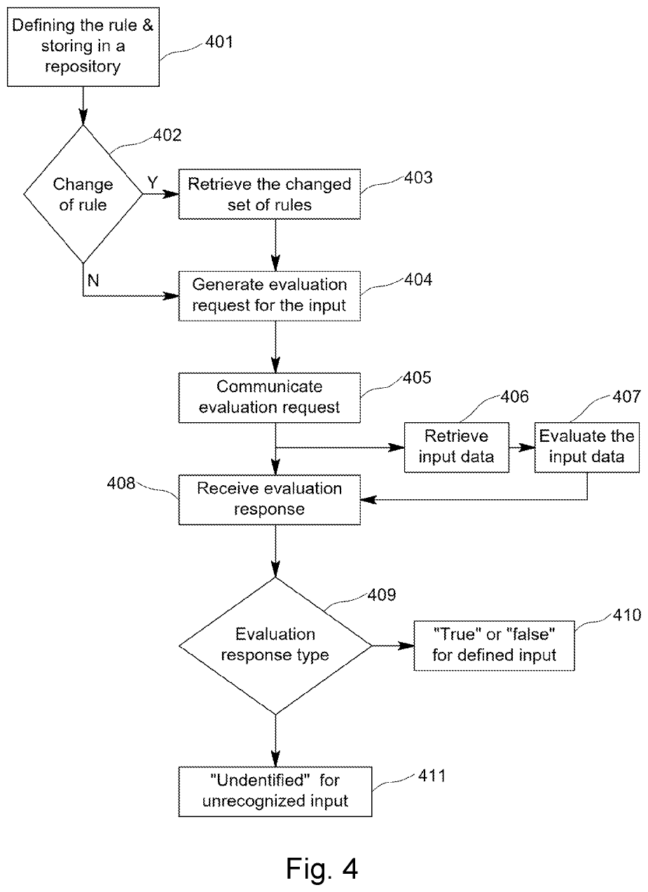

Referring to FIG. 4, the evaluation of feature flags comprising steps of defining set of rules (policy) using declarative query language 401; monitoring and checking for any update or change in the rule(s) 402 as defined in the policy; if there is a change in rule retrieving the changed set of rules 403; generating evaluation request for the input 404; communicating the evaluation request 405; receiving the evaluation response 406; retrieving the input data from the client database 407; evaluating the input data using the set of rules 408; determining the response type 409; generating “true” or false” as response 410 for the consistent input data; and generating “undefined” as response 411 for inconsistent input data.

During evaluation of the flags, the outputs can be in the form of Boolean, and the present feature flag service does not evaluate to {true, false}. For example, a rule may look like:

enterprise_feature_is_permitted {
inputs. actor.subscription_tier in [“GOLD”]
}

Here ‘enterprise_feature_is_permitted’ is a flag that evaluates to true only if the requesting actor's subscription tier is GOLD.

If the rule changes that is if both GOLD and SILVER actors are permitted to use the feature, then the policy could be updated to:

enterprise_feature_is_permitted {
inputs. actor.subscription_tier in [“GOLD”, “SILVER”]
}

Once the change is merged, the feature flags service will propagate the updated policy to the system's software services and they will start evaluating true for any SILVER actors without requiring any updates or restarts.

In the current embodiment, during the evaluation of the flags, the outputs can be in the form of Boolean, and the present feature flag service does not evaluate to {true, false}, but rather {true, false, undefined} (or for string/numeric flags, also add the ‘undefined’ value). If an unrecognized or incompatible input is provided, rather than erroneously evaluating a ‘true/false’ value, the present feature flag service will define it as an ‘undefined’ output which thereby requests the developer's attention to check the input variables as to whether they are consistent with the defined rule or policy. This is made practical by the Rego policy language that is used to define the rules (policy), which ensures consistency by always producing a consistent result, although that result may be “undefined”. To further elaborate, if the new rule relies on an input that is not present in the old rule, the new rule will not fail because clients are not providing the new input, instead the new input evaluates to “undefined”, and the rule is still successfully evaluated. As for other incompatible changes, the evaluation will always succeed; it just may be the case that the resulting value is “undefined” like in case there are two rules and one rule evaluated ‘true’ for an actor and other rule evaluates to ‘false’ this will be undefined.

In an embodiment, the client can validate the consistency of the policy by using the version ID, which is the git commit ID. The git commit ID is a derivative of the policy data (it is a Merkle tree), so it can verify it has a proper policy by performing the computation and generating the same ID. If the policy is inconsistent, then generally flag evaluations would fall back to “undefined,” meaning the client will decide how to react.

In another embodiment, the contextual input data is evaluated using feature flags that comprise steps of initiating an evaluation request 501; accessing the available feature flag 502 defined by a set of rules; retrieving the contextual data 503 from the cloud storage; feeding any special headers into the rule evaluation 504; evaluating the contextual input using an available version of rules 505; generating the response/output data 506; identifying any ‘undefined’ output 507; communicating the evaluated results 508; and if undefined response generated, prompting the user to check the inconsistency 508. The special headers may include input data of the user credentials which may allow the feature to run or be disabled.

In accordance with the present specification, the developer ensures that the policy changes are “safe”, where the tests shall add cases for old clients when adding new rules. If an error is made, the safety net is to make the flag evaluate to ‘undefined’ which should default to the most conservative behavior (e.g. if a security flag goes wrong, deny permission by default). To expand a little further on ‘undefined’ evaluation, let's say the flag rule expects an input ‘input.client_data’ but the client doesn't provide it. In typical software languages, variables are initialized to the “zero value”, which might be the empty string for the string case. So conventionally, this rule would evaluate to ‘false’:

feature_is_disabled {
input.client_data == “some_value” // “” != “some_value”
}

Rego is a declarative query language that defines the rules in accordance with an embodiment of the present specification and the present feature flag service will implement this policy language and defaults variables to ‘undefined’ if the input data is not recognized by the rule instead of generating a ‘false’ response for such unrecognized data content.

In another embodiment, the feature flags themselves do not carry any strict dependencies between each other. So, the evaluation of old/new input values is entirely independent. There are three “tiers” of variables in the feature flag policy definition (i.e., the rules): (i) Inputs—These are provided by the client/environment; (ii) Intermediate values—These are calculated from the inputs; and (iii) Flag values (outputs)—These are calculated from the intermediate values/inputs.

In another embodiment, the dependencies between flags will be traversed if there are no cycles. Evaluating dependencies between feature flags which includes steps of defining an intermediary feature flag(s) that is evaluated against at least one feature flag at a time and proceeding with the next feature flag if the response generated for the evaluation of the previous feature flag is a defined type (like either ‘true’ or ‘false’) of response. For any two feature flags if dependent on each other, an intermediary feature flag is defined wherein this intermediary feature flag is evaluated against the first feature flag and if the response is defined then the intermediary feature flag is evaluated against the second feature flag. For example, there are two different flags “social_enabled” and “can_send_messages”, where “can_send_messages” should only be true if “social_enabled” is true. Here, an intermediate value like “tmp_social_enabled” is created and rules then the evaluation is followed in steps as: “social_enabled=tmp_social_enabled”, and then check for: “can_send_messages=tmp_social_enabled && . . . other logic . . . ”. It is as if “social_enabled” is evaluated first, and the result is then used to evaluate “can_send_messages.”

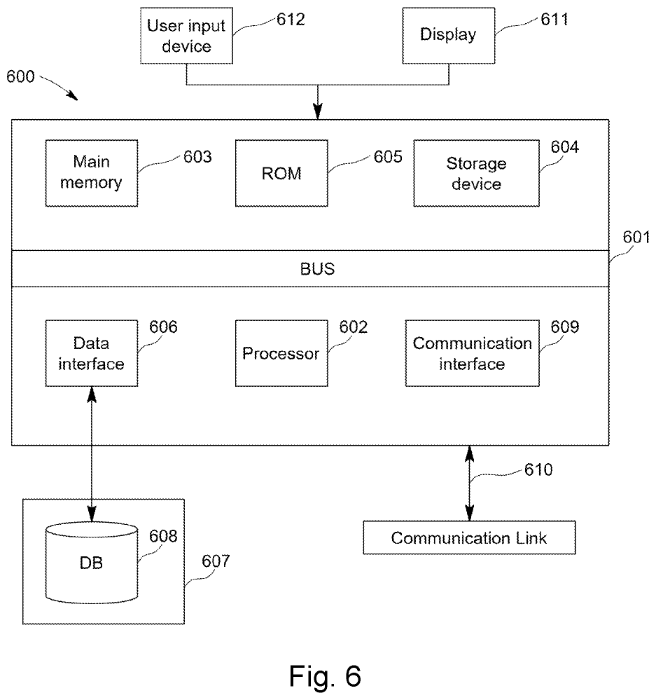

FIG. 6 is a block diagram of an illustrative computing system 600 suitable for implementing an embodiment of the present invention. Computer system 600 includes a bus 601 or another communication mechanism for communicating information, which interconnects subsystems and devices, such as processor 602, system memory 603 (e.g., RAM), static storage device 604 (e.g., ROM), disk drive 605 (e.g., magnetic, or optical), communication interface 609 (e.g., modem or Ethernet card), display 611 (e.g., CRT or LCD), input device 612 (e.g., keyboard), and cursor control.

According to one embodiment of the invention, computer system 600 performs specific operations by processor 602 executing one or more sequences of one or more instructions contained in system memory 603. Such instructions may be read into system memory 603 from another computer readable/usable medium, such as static storage device 604 or disk drive 605. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer-readable medium” or “computer-usable medium” as used herein refers to any medium that participates in providing instructions to processor 602 for execution. Such a medium may take many forms, including but not limited to, non-volatile media and volatile media. Non-volatile media includes, for example, optical or magnetic disks, such as disk drive 605. Volatile media includes dynamic memory, such as system memory 603. database 608 may be accessed in a computer-readable medium 607 using a data interface 606.

Common forms of computer-readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip, or cartridge, or any other medium from which a computer can read.

In an embodiment of the invention, execution of the sequences of instructions to practice the invention is performed by a single computer system 600. According to other embodiments of the invention, two or more computer systems 600 coupled by communication link 610 (e.g., LAN, PTSN, or wireless network) may perform the sequence of instructions required to practice the invention in coordination with one another.

Computer system 600 may transmit and receive messages, data, and instructions, including program, i.e., application code, through communication link 610 and communication interface 609. Received program code may be executed by processor 602 as it is received, and/or stored in disk drive 605, or other non-volatile storage for later execution.

In a typical configuration, the computer includes one or more processors (CPU), an input/output interface, a network interface, and a memory. The memory can include a non-persistent memory, a random-access memory (RAM), and/or a nonvolatile memory in a computer-readable medium, for example, a read-only memory (ROM) or a flash memory (flash RAM). Memory is an example of a computer-readable medium.

Features described as separate implementations may be implemented, in combination, in a single implementation, while features described as a single implementation may be implemented in multiple implementations, separately, or in any suitable sub-combination. Operations or processes or methods described and claimed in a particular order should not be understood as requiring that particular order, nor that all illustrated operations must be performed (some operations can be optional). As appropriate, multitasking or parallel processing (or a combination of multitasking and parallel processing) can be performed.

Specific implementations of the present specification are described above. Other implementations fall within the scope of the appended claims. In some situations, the actions or steps described in the claims can be performed in an order different from the order in the implementations and the desired results can still be achieved. In addition, the process described in the accompanying drawings does not necessarily need a particular execution order to achieve the desired results. In some implementations, multitasking and parallel processing can be advantageous.

The descriptions above are only example implementations of one or more implementations of the present specification but are not intended to limit one or more implementations of the present specification. Any modification, equivalent replacement, improvement, etc. made without departing from the scope and principle of one or more implementations of the present specification shall fall within the protection scope of the one or more implementations of the present specification.

What is claimed is:

1. A method for evaluating feature flag(s), comprising:
defining and storing a set of rules in a repository;
monitoring any change or update in rule(s);
retrieving the latest version of the rules stored in the repository;
generating evaluation request by a client system;
communicating such evaluation request to feature flag service;
retrieving input data from a client database;
evaluating the input data using the latest version of the rule(s); and
generating response data, wherein the response data can be defined type for consistent data and undefined type for any inconsistent input data that is retrieved from the client database by the feature flag service.

2. The method of claim 1 wherein defining rules comprises steps of defining a rule in declarative query format; assigning an identifier to the defined rule; and storing the defined rule with identifier in a repository.

3. The method of claim 1 wherein defining rules is achieved using a declarative query language.

4. The method of claim 1 wherein the set of rules form a policy that is stored in a repository of a source version control system on distributed storage.

5. The method of claim 1 further comprises updating or changing of rule(s) which comprises steps of initiating update request; redefining the rule(s); merging the update request; assigning a new identifier to an updated version of rule(s); and storing the updated rule(s) in the same repository.

6. The method of claim 1 wherein a defined type of response data is of a Boolean value corresponding to ‘true’ and ‘false’, or numeric value or string value.

7. The method of claim 1 wherein an undefined type of response data corresponds to ‘undefined value’, ‘undefined input’ for an unrecognized or inconsistent type of input data.

8. The method of claim 1 further comprises monitoring of dependencies between feature flags which includes defining an intermediary feature flag(s) that is evaluated against at least one feature flag at a time and proceeding with the next feature flag if the response generated for the evaluation of a previous feature flag is a defined type of response.

9. A system for evaluating feature flag(s) comprising a repository for storing a set of rules and a feature flag service that monitors the set of rules and identifies any update or change in such set of rules, wherein input data is evaluated with a feature flag to generate a defined and undefined type of response output data.

10. The system of claim 9 wherein the set of rules is defined using a declarative query language.

11. The system of claim 9 wherein the set of rules forms a policy that is stored in a repository of a source version control system on distributed storage.

12. The system of claim 9 wherein each rule is assigned with an identifier.

13. The system of claim 9 wherein the defined type of response data is of a Boolean value corresponding to ‘true’ and ‘false’, or numeric value or string value.

14. The system of claim 9 wherein the undefined type of response data corresponds to ‘undefined value’, ‘undefined input’ for the unrecognized or inconsistent type of input data.

15. The system of claim 9 wherein the feature lag service further monitor dependency between feature flags by defining an intermediary feature flag(s) which is evaluated against at least one feature flag at a time and proceeds with the next feature flag if the response generated for the evaluation of a previous feature flag is a defined type of response.

16. A computer processing system comprises a processing unit; a communications interface; and
a non-transitory computer-readable storage medium to store instructions, wherein the processing unit execute the stored instructions to perform:
defining and storing a set of rules in a repository;
monitoring any change or update in rule(s);
retrieving the latest version of the rules stored in the repository;
generating evaluation request by a client system;
communicating such evaluation request to feature flag service;
retrieving input data from a client database;
evaluating the input data using the latest version of the rule(s); and
generating response data, wherein the response data can be defined type for consistent data and undefined type for any inconsistent input data that is retrieved from the client database by the feature flag service.

17. The computer-readable medium of claim 16 wherein the computer executable instructions that when executed by a processor of a computer, allows the processor to perform defining rules that further comprising: defining a rule in declarative query format; assigning an identifier to the defined rule; and storing the defined rule with identifier in a repository.

18. The computer-readable medium of claim 16 wherein the computer executable instructions that when executed by a processor of a computer, allows the processor to perform updating or changing of rule(s) that further comprising: initiating update request; redefining the rule(s); merging the update request; assigning a new identifier to updated version of rule(s); and storing the updated rule(s) in the same repository.

19. The computer-readable medium of claim 16 wherein the computer executable instructions that when executed by a processor of a computer, allows the processor to perform monitoring of dependencies between feature flags that further comprising: defining an intermediary feature flag(s) that is evaluated against at least one feature flag at a time and proceeding with the next feature flag if the response generated for the evaluation of a previous feature flag is a defined type of response.

20. A method to facilitate the evaluation of feature flags, wherein the feature flags are operated by a set of rules also defined as a policy, wherein these feature flags operate when such conditions as prescribed in the policy are satisfied, wherein the system store rules in a repository by assigning a unique identifier to each rule, wherein the system facilitates updating a rule, assignment of new version identifier to the updated rule, wherein a declarative query language is used for the rules to allow rule evaluation where inputs are provided to the rule evaluation that affects the resulting value that is of a defined type or an undefined type.
